(19) United States
(12) Patent Application Publication
(10) Pub. No.: US 2013/0020521 A1
(43) Pub. Date: Jan. 24, 2013

(54) PRECONFIGURED SEAL FOR VALVE ASSEMBLIES

(71) Applicant: Joseph H. Byrne, Hudson Oaks, TX (US)

(72) Inventor: Joseph H. Byrne, Hudson Oaks, TX (US)

(73) Assignee: S.P.M. FLOW CONTROL, INC., Fort Worth, TX (US)

(21) Appl. No.: 13/445,513

(22) Filed: Apr. 12, 2012

Related U.S. Application Data
(60) Provisional application No. 61/475,418, filed on Apr. 14, 2011.

(51) Int. Cl. F16K 1/00; B21K 1/24

(52) U.S. Cl. 251/334; 29/890.122; 251/359

(57) ABSTRACT

A valve assembly is disclosed herein having a valve member and a valve seat body. The valve member is reciprocatingly movable into and out of engagement with the valve seat body. The assembly further includes at least one deformable seal positioned to be at the situs of engagement of the valve member with the valve seat body. The at least one seal is preconfigured with a recess facing the situs to form a pocket to trap fluid therein as the valve member approaches the engagement, which reduces the velocity of the valve member moving toward the engagement and reduces the impact force of the valve member on the valve seat body. Furthermore, the fluid disposed within the pocket also reduces the axial load on the valve member and valve seat body.

### CROSS-REFERENCE TO RELATED APPLICATIONS

This application claims priority to U.S. Provisional Patent Application Ser. No. 61/475,418, filed on Apr. 14, 2011, which is incorporated herein by reference in its entirety.

### TECHNICAL FIELD

This disclosure relates in general to valve assembly seals, more particularly to valve assemblies incorporating uniquely preconfigured seals, and even more particularly to valve assemblies as incorporated with reciprocating pumps.

### BACKGROUND OF THE DISCLOSURE

Large pumps are commonly used for mining and oilfield applications, such as, for example, hydraulic fracturing. During hydraulic fracturing, fracturing fluid (i.e., cement, mud, frac sand and other material) is pumped at high pressures into a wellbore to cause the producing formation to fracture. One commonly used pump in hydraulic fracturing is a high pressure reciprocating pump, like the SPM® Destiny™ TWS 2500 frac pump, manufactured by S.P.M. Flow Control, Inc. of Fort Worth, Tex. Accordingly, the fracturing fluid is caused to flow into and out of a pump fluid chamber as a consequence of the reciprocation of a piston-like plunger respectively moving away from and toward the fluid chamber. As the plunger moves away from the fluid chamber, the pressure inside the chamber decreases, creating a differential pressure across an inlet valve, drawing the fracturing fluid through the inlet valve into the chamber. When the plunger changes direction and begins to move towards the fluid chamber, the pressure inside the chamber substantially increases until the differential pressure across an outlet valve causes the outlet valve to open, enabling the highly pressurized fracturing fluid to discharge through the outlet valve into the wellbore.

Because of the high operating pressures (oftentimes up to 15,000 psi) and the abrasive solid particles associated with the fracturing fluid, the mating surfaces on valves and valve seats tend to wear at a rapid rate, and thus, the valves and valve seats are replaced frequently. This is principally due to the extremely high fluid pressures creating excessive axial loads on the mating surfaces, which become worn and pitted due to particulate from the fracturing fluid being trapped therebetween. In addition, a significant amount of damage occurs to the valve assembly as a result of high impact force contact between the valve body with the valve seat as a consequence of the valve body rapidly approaching the valve seat. Thus, there is a need for a valve assembly in which, inter alia, the excessive axial loads and impact forces are reduced, if not eliminated, to thereby increase the life of the overall valve assembly.

### SUMMARY

In a first aspect, there is provided a valve assembly including a valve member and a valve seat body. The valve member is reciprocatably movable toward and away from mating engagement with the valve seat body. The assembly further includes at least one deformable seal positioned to be at the situs of engagement of the valve member with the valve seat body. The seal is preconfigured with a recess facing the situs to form a pocket to trap fluid therein as the valve member approaches the engagement. This reduces the velocity of the valve member when moving toward the engagement, and thus, reduces the impact force of the valve member on the valve seat body. In addition, the axial load on the mating engagement surfaces of the valve member and valve seat body is reduced due to the trapped fluid in the recess. Thus, the overall life of the valve assembly can be extended.

In certain embodiments, the deformable seal is positioned on the valve seat body.

In other certain embodiments, the deformable seal is positioned at least partially within a cavity on the valve seat body.

In yet another embodiment, the valve assembly also includes a seal on the valve member to contact the valve seat body seal as the valve member approaches the engagement.

In still yet another embodiment, the valve assembly includes a seal on the valve member to contact the seal on the valve seat body as the valve member approaches the engagement. The valve member seal includes a recess facing the recess on the valve seat body seal to form a pocket to trap fluid therein as the valve member approaches the engagement.

In yet another embodiment, the pocket remains in the at least one seal after the engagement.

In yet another embodiment, the recess is arcuately formed on the seal.

In yet another embodiment, the seal is formed of urethane.

In still yet another embodiment, the valve seat body has an inclined seating surface disposed at an angle from about 30 degrees to about 45 degrees relative to a plane that is perpendicular to a central axis of the valve assembly.

In a second aspect, there is provided a valve assembly incorporated with a reciprocating pump, the valve assembly movable between an open position and a closed position for respectively opening and closing a fluid chamber of the pump. The valve assembly includes a valve member reciprocatably movable between the open and closed positions, the valve member having an engagement surface. The assembly further includes a valve seat body having a seating surface, the engagement surface of the valve member being biased into engagement with the seating surface of the valve seat body in the closed position and biased out of engagement from the seating surface in the open position. The assembly also includes at least one deformable seal disposed at the situs of the engagement between the engagement surface and seating surface. The seal is preconfigured with a recess facing the situs to form a pocket to trap fluid therein as the valve member approaches the engagement. This reduces the velocity of the valve member toward, and reduces the impact force at, the engagement. In addition, the axial load on the mating engagement surfaces of the valve member and valve seat body is reduced, thus increasing the overall life of the valve assemblies of the pump.

In certain embodiments, at least one deformable seal is disposed on the seating surface.

In other certain embodiments, at least one deformable seal is disposed at least partially within a cavity on the seating surface.

In yet another embodiment, the recess is arcuately formed on at least one deformable seal.

In another embodiment, the valve assembly includes a seal disposed on the engagement surface to contact the at least one deformable seal on the seating surface as the valve member moves toward the closed position.

In still another embodiment, the engagement surface seal is disposed at least partially within a cavity on the engagement surface.

In still another embodiment, the valve assembly further includes a seal disposed on the engagement surface to contact the at least one deformable seal on the seating surface as the valve member moves toward the closed position. The engagement surface seal includes a recess facing the recess on the at least one deformable seal to form a pocket to trap pressurized fluid therein.

In a third aspect, there is provided a method of manufacturing a valve for a reciprocating pump. The method includes providing a valve seat body having a tubular shaped member therethrough and a seat surface. The method further includes positioning a valve member at least partially within the tubular shaped member, the valve member having an engagement surface to contact the seat surface when the valve member is in a closed position. Furthermore, the method includes securing a seal to at least one of the seat surface or the engagement surface, the seal having a preconfigured recess disposed therein to form a pocket to trap fluid therein as the valve member approaches the closed position. The fluid within the pocket decreases the impact force of the valve member on the valve seat body as well as reduces the axial load on the mating engagement surfaces of the valve member and valve seat body, since the trapped high pressure fluid produces an axial load opposite to the axial load force that forces the valve closed. Thus, the overall life of the valve assembly is increased.

In certain embodiments, the step of securing the seal to at least one of the seat surface or the engagement surface includes securing the seal within a cavity.

In a fourth aspect, there is provided a deformable seal for use with a reciprocating pump valve assembly. The valve assembly includes a valve seat body having a seat surface and a valve member having an engagement surface for contacting the seat surface at a situs of engagement when the valve member moves to a closed position. The deformable seal includes a first surface, a second surface and a pair of side surfaces, and a recess formed in the second surface. The recess is adapted to face the situs of engagement such that as the valve member moves from an open position to the closed position, fluid is trapped within the second surface recess to reduce the velocity of the valve member toward, and reduce the impact force on, the seat surface, to thereby increase the life of the valve assembly. In addition, the axial load on the mating engagement surfaces of the valve member and valve seat body is reduced. These advantages improve the overall life of the valve assembly.

In other certain embodiments, the first surface and at least a portion of the side surfaces are adapted to be disposed within a cavity on the seat surface or the engagement surface.

In other certain embodiments, the deformable seal is combined with a valve member.

In yet other certain embodiments, the deformable seal is combined with a valve member as shown and described herein.

In a fifth aspect, there is provided a valve assembly having a valve seat body and a valve member reciprocatably movable into and out of engagement with the valve seat body. The assembly further includes a first deformable seal positioned in the valve seat body and preconfigured with a recess. In addition, a second deformable seal is positioned on the valve member and is preconfigured with a recess. The recesses on the first and second deformable seals are aligned and facing one another to form a pocket to trap fluid therein as the valve member approaches the valve seat body. This reduces the velocity of the valve member toward, and reduces the impact force against, the valve seat body in order to increase the life of the valve assembly. In addition, the axial load on the mating engagement surfaces of the valve member and valve seat body is reduced. Such advantages are directed to increasing the overall life of the valve assembly.

In a sixth aspect, there is provided a valve assembly manufactured with a valve member movable between an open position and a closed position, the valve member having an engagement surface for contacting a valve seat having a seating surface. The valve assembly includes a deformable seal disposed on the engagement surface or the valve seat surface, at least one deformable seal preconfigured with a recess for facing the seating surface or engagement surface without the deformable seal so as to trap fluid therein as the valve member moves to the closed position.

In a seventh aspect, there is provided a valve assembly including a valve member having an engagement surface a valve seat body having a seating surface. The valve member is reciprocatably movable into and out of engagement with the valve seat body. At least one of the engagement surface or the seating surface include a recessed portion disposed between a first deformable seal and a second deformable seal. The recessed portion and the first and second seals face the situs of engagement to form a pocket to trap fluid therein as the valve member approaches the engagement. This reduces velocity of the valve member moving toward the engagement, reduces the impact force of the valve member on the valve seat body and reduces the axial load on the valve member and valve seat body.

Other aspects, features, and advantages will become apparent from the following detailed description when taken in conjunction with the accompanying drawings, which are a part of this disclosure and which illustrate, by way of example, principles of the inventions hereof.

### DESCRIPTION OF THE FIGURES

The accompanying drawings facilitate an understanding of the various embodiments.

FIG. 1 is an side sectional view of a valve assembly in which at least one deformable seal, preconfigured in accordance with a first embodiment of the assembly, is employed.

FIG. 2A is an enlarged view of a portion of the valve assembly of FIG. 1.

FIG. 2B is an enlarged view of a portion of the valve assembly of FIG. 1 positioned in the closed position.

FIG. 3 is an enlarged view of a portion of a valve assembly in accordance with a second embodiment of the assembly.

FIG. 4 is an enlarged view of a portion of a valve assembly in accordance with a third embodiment of the assembly.

FIG. 5 is an enlarged view of a portion of a valve assembly in accordance with a fourth embodiment of the assembly.

FIG. 6 is an enlarged view of a portion of a valve assembly in accordance with a fifth embodiment of the assembly.

FIG. 7 is a simplified diagrammatic illustration of a portion of a reciprocating pump apparatus incorporating any of the valve assemblies described herein as the inlet and outlet valves of the pump fluid chamber.

### DETAILED DESCRIPTION

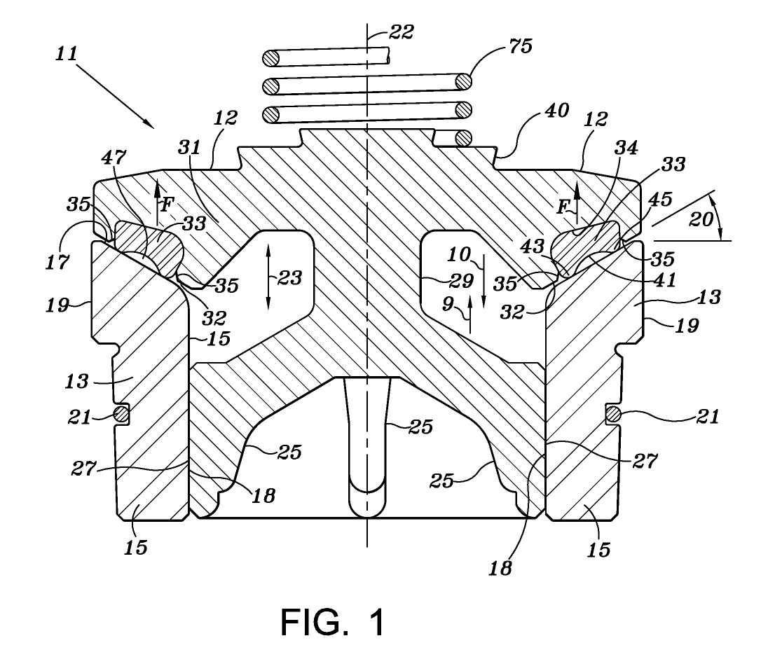

Referring now to FIG. 1, a valve assembly 11 includes a reciprocatably movable valve member 12 adapted for movement into and out of engagement (as illustrated by arrow 23) with a valve seat body 13. As illustrated in FIG. 1, the valve assembly 11 incorporates at least one deformable seal 33 positioned at the situs of engagement between the valve member 12 and the valve seat body 13 such that, as explained in greater detail below, the seal 33 forms a pocket 47 to trap fluid therein as valve member 12 approaches the engagement to otherwise seat against the valve seat body 13 in a closed position. By trapping fluid within the pocket 47, pressure therein is increased thereby creating a force F acting opposite to a valve closing force such that when the valve assembly 11 reaches the closed position, the axial load on the valve member 12 and the valve seat body 13 is reduced. Furthermore, the seal 33 and the pocket 47 are positioned and otherwise formed to reduce the velocity of the valve member 12 moving toward the engagement and thus, reduces the impact force of the valve member 12 on the valve seat body 13.

The valve seat body 13, typically formed of metal such as cast steel, is preferably a tubular shaped member 15 defining an inner wall portion 18 symmetrically and axially disposed around a central axis 22. The valve seat body 13 has an inclined/conical seating surface 17 at its upper end that extends from an inner wall portion 18 to an outer wall portion 19. In the embodiment illustrated in FIG. 1, the conical contour of seating surface 17 is disposed at an angle 20, which is relative to a plane that is perpendicular to the central axis 22, and which in the embodiment shown also corresponds to the angle of the engagement surface 32 on the valve member 12. The angle 20 is provided preferably in one embodiment from about 30 degrees to about 45 degrees. In other embodiments, the angle 20 is from about 30 degrees to about 40 degrees, from about 30 degrees to about 35 degrees, from about 35 degrees to about 45 degrees, from about 35 degrees to about 40 degrees, from about 40 degrees to about 45 degrees, greater than 30 degrees, or less than 45 degrees; however, the range of the angle 20 may vary. Furthermore, when the valve assembly 11 is used with a reciprocating pump, it is desirable to have an annular seal 21 extending around the exterior of the seat body 13 to enable it to seal when mounting within a flow passage of the pump.

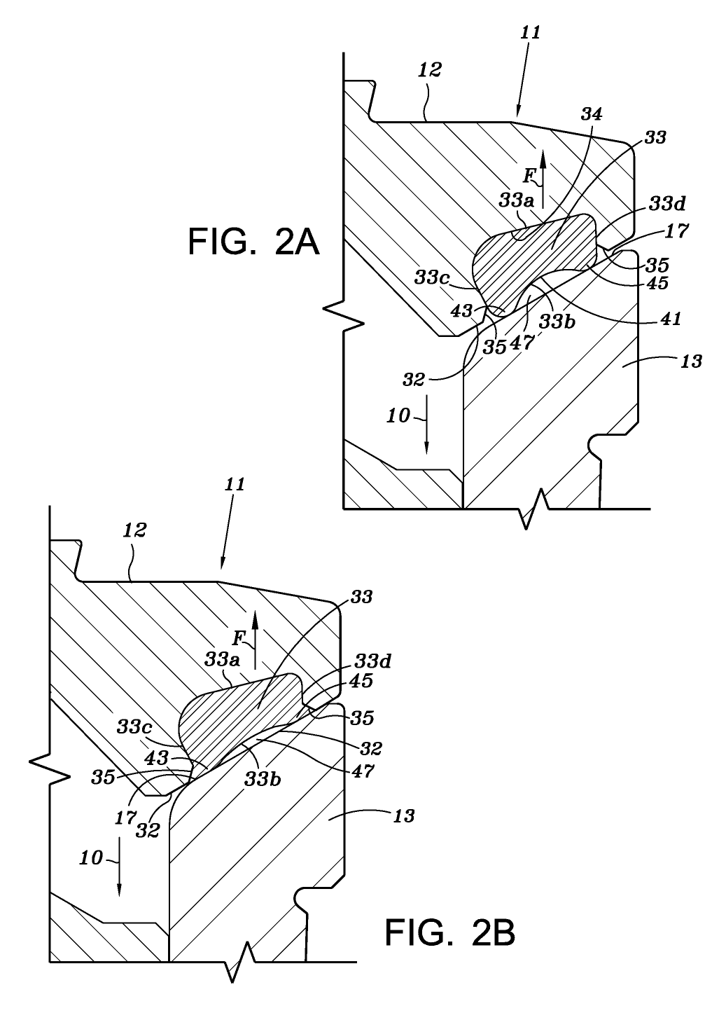

The valve member 12, also formed of metal such as cast steel, is reciprocatably movable between an open position (i.e., the valve member 12 is spaced apart from the valve seat body 13), and a closed position (i.e., the valve member 12 mates with and otherwise engages the valve seat body 13 as illustrated in FIG. 2B) in response to differential pressure within the pump. In FIG. 1, the valve member 12 includes three legs 25 having outer ends 27 slideably engaging the inner sidewall 18 of the tubular shaped member 15. The legs 25 are secured to or otherwise integral with a central stem 29, which extends upwardly along the central axis 22 to an upper valve body portion 31. In the embodiment illustrated in FIG. 1, an upper valve body portion 31 flares radially outward from the stem 29 and has a downwardly and outwardly-facing annular seal/engagement surface 32 at its outer diameter.

The engagement surface 32 of the valve member 12 is biased into engagement with the seating surface 17 of the valve seat body 13 in the closed position, and biased out of engagement from the seating surface 17 in the open position. For example, a boss 40 extends from the upper end of the upper valve body 31 and is coaxial with the central axis 22. A biasing member such as a coiled spring 75 is disposed between the boss 40 and a portion of the manifold housing of the pump (not illustrated). In operation, differential pressure acting on the valve body portion 31 causes the valve member 12 to move in the direction of upward (direction shown by arrow 9) to separate the engagement surface 32 from the seating surface 17. This movement compresses coiled spring 75 and enables fluid flow through the tubular shaped member 15 and between engagement surface 32 and seating surface 17. At the end of the pump stroke, the stored energy in coiled spring 75 overcomes the differential pressure and exerts a closing force on the valve member 12 to move the valve member 12 in a downward direction (direction shown by arrow 10) to the closed position (FIG. 2B), thereby preventing fluid flow between the engagement surface 32 and the seating surface 17.

Referring specifically to FIGS. 2A and 2B, the deformable seal 33 is formed of a first surface 33a, a second surface 33b, and a pair of side surfaces 33c and 33d. The seal 33 is preconfigured with an annular concave recess 41 formed on the second surface 33b and is positioned such that the recess 41 faces the seat surface 17 to form the pocket 47 to trap fluid therein as the valve member 12 approaches the valve seat body 13. As illustrated in FIGS. 2A and 2B, the recess 41 arcuately extends between an inner base portion 43 and an outer base portion 45; however, the shape of recess 41 may be otherwise configured (i.e., rectangular, square, etc.) and formed of any size (wider, narrower, increased depth or decreased depth, etc.). In addition, while the seal 33 contains a single recess 41 therein, the seal 33 may be pre-configurable with a series of smaller recesses formed therein such that the seal 33 includes a series of peaks and valleys, for example. Furthermore, the engagement surface 32 is configurable to receive more than one deformable seal 33 thereon such that a first deformable seal 33 is encircled and otherwise surrounded by a second deformable seal 33 disposed at the engagement surface 32.

Preferably, the engagement surface 32 includes an annular cavity 34 for securing the seal 33 therein, although the engagement surface 32 is optionally formed without an annular cavity 34 such that the seal is directly couplable to the engagement surface 32 via an adhesive or otherwise. The annular cavity 34 is generally centrally disposed at the engagement surface 32; however, the annular cavity 34 may be otherwise positionable (i.e., non-centrally disposed on surface 32 so that cavity 34 is either closer to the tubular shaped member 15 or further away from tubular shaped member 15). Furthermore, in addition to being positioned anywhere on the surface 32, the cavity 34 can be of any width, depth and/or shape to secure seal 33 therein. In the embodiment illustrated in FIGS. 1, 2A and 2B, the annular cavity 34 optionally includes chamfers 35 to enable the seal 33 to deform at least partially within the space defined by the chamfers 35. Deformation of the seal 33 within the space defined by the chamfers 35 enables metal to metal contact between the surfaces 17 and 32 without causing damage to the seal 33.

In operation, as the valve member 12 moves in a downward direction (direction shown in arrow 10) to the closed position, the seal 33, and in particular the inner base 43 and the outer base 45 portions, initially contact the seating surface 17 (FIG. 2A). Upon initial contact, the recess 41 and the seating surface 17 form the pocket 47 to trap fluid therein. As illustrated in

FIG. 2B, continued movement of the valve member 12 toward the closed position compresses and otherwise deforms the seal 33, which also forces small amounts of fluid to exit the pocket 47. This slows the velocity of the valve member 12 toward the valve seat 13, and thus, reduces the impact force and metal-to-metal contact between the seating surface 17 and the engagement surface 32. In addition, by trapping fluid in the pocket 47, as the valve member 12 continues toward and reaches the closed position, the pressure buildup in the pocket 47 creates a force F, which acts against the closing force on the valve member 12. Accordingly, when the engagement surface 32 contacts the seating surface 17 resulting in metal-to-metal contact, the closing pressure force is reduced by the opposite acting pressure force F, which reduces the axial load on the valve member 12 and the valve seat body 13. As such, any damage to the surfaces 17 and 32 caused by fracturing fluid particulate being sandwiched therebetween is substantially reduced. Furthermore, since a defined volume of fracturing fluid remains within the pocket 47, the particulate remains floating within the fracturing fluid and does not directly press against the surfaces 17 and 32, thereby further minimizing and/or substantially eliminating pitting and wear on the surfaces 17 and 32. In addition, as the pressure differential across the valve assembly 11 changes, force F also acts to lift the valve member 12 away from the valve seating surface 13.

The seal 33 is preferably formed of a conventional thermoplastic material including, for example, urethane. In addition, the seal 33 optionally includes fiber or organic reinforcement such as, for example, carbon fibers, glass fibers, cotton fibers, or other organic reinforcing material, or combinations thereof, that can be either randomly disposed or specially oriented within the seal. The fiber reinforcement is optionally formed of flat woven fabrics or fiber webs that include fiber bundles having a large number of individual fibers. Fiber reinforcement is utilized to prevent and/or otherwise reduce the likelihood of delamination of the seal 33. Optionally, the seal 33 is formed having a hardness of 95A durometer, or greater. For example, the seal 33 is formed to have a hardness value of 60D durometer or more but in no event, greater than the hardness and rigidity of the valve member 12 and/or the valve body 13.

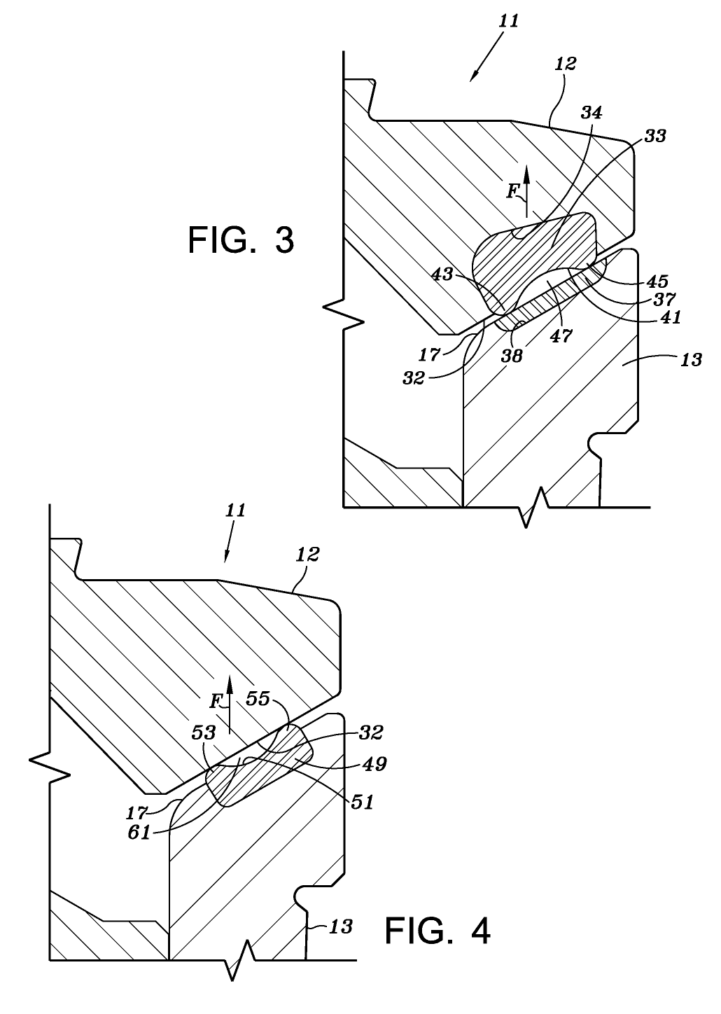

In the alternate embodiment illustrated in FIG. 3, the valve seat body 13 includes an additional seal 37 disposed within a cavity 38 at the valve seat body surface 17. The valve seat seal 37 is preferably of the same thermoplastic material used in connection with the seal 33 and extends at least the same distance along a seating surface 17 as the seal 33 extends along the engagement surface 32. Therefore, as the valve member 11 moves toward the seat body 13, the seal 33 contacts the seal 37 without contacting the seating surface 17.

As the valve member 12 moves toward the closed position, the portions 43 and 45 of the seal 33 initially contact the seal 37 on the valve seat body 13 to create a pocket or chamber 47 for trapping drilling, mining slurry, or fracturing fluid therein. Continued movement of the valve member 12 toward the closed position compresses and/or otherwise deforms the seals 33 and 37, which also forces fluid to exit the pocket 47. This slows the velocity of the valve member 12 toward the valve seat body 13, and thus, reduces the impact force and metal-to-metal contact between the seating surface 17 and the engagement surface 32. In addition, because of the high pressure, fluid trapped within the pocket 47 is compressed, further reducing the velocity of the valve member 12 as it approaches the valve seat body 13. When metal-to-metal contact occurs (i.e., when the surfaces 17 and 32 contact), fluid remains inside the pocket 47 but at a reduced volume. As previously described, the pressure of the trapped fluid inside the pocket 47 creates a force F, which acts against the valve closing force to reduce the axial load on, and thus damage to, the valve member 12 and the valve seat body 13.

In yet another embodiment illustrated in FIG. 4, the seal 33 is omitted from the valve member 12. In particular, the valve assembly 11 includes a deformable seal 49 disposed on the valve seat body. The seal 49 is oriented such that a concave recess 51 preconfigured within the seal 49 faces an engagement surface 32 on the valve member 12. In operation, as the valve member 12 approaches the valve seat body 13, the engagement surface 32 initially contacts the portions 53 and 55 to form an enclosed pocket 61 to trap fluid therein. As previously explained, continued movement of the valve member 12 toward the closed position compresses and/or otherwise deforms the seal 49, which also forces fluid to exit the pocket 61. This slows the velocity of the valve member 12 toward the valve seat body 13, and thus, reduces the impact force, as well as reduces the axial force upon the mating or engaging surfaces which normally results from metal-to-metal contact between the valve member 12 and the valve seat body 13.

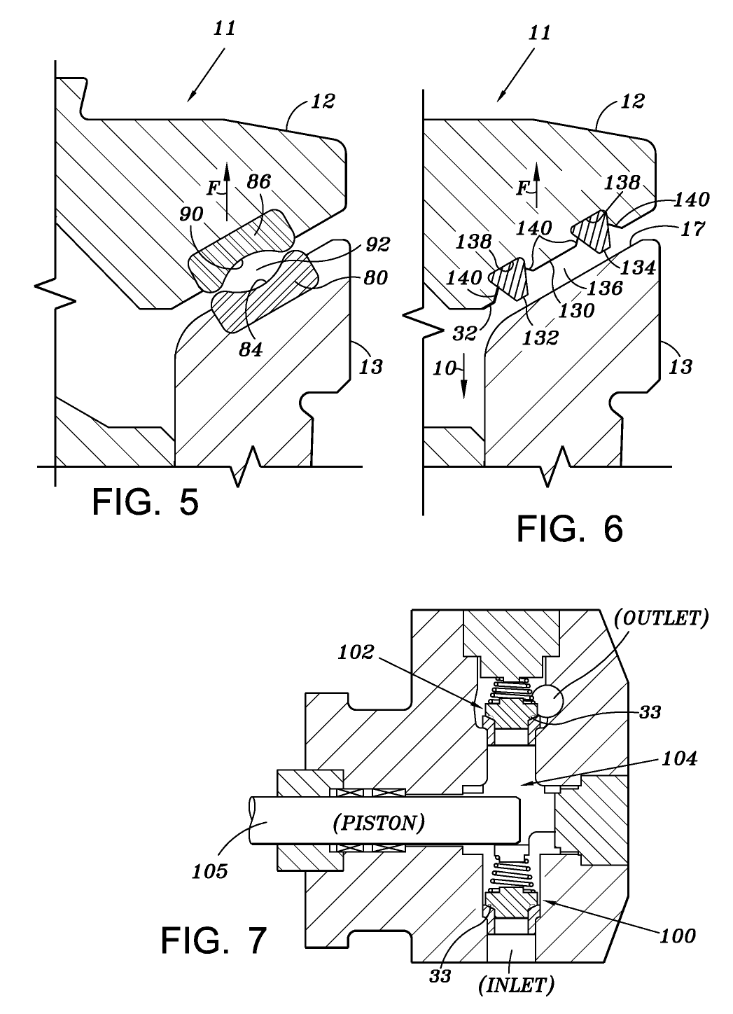

FIG. 5 is yet another alternative embodiment of the valve assembly 11. In the embodiment illustrated in FIG. 5, the valve assembly 11 includes a first deformable seal 86 in the valve member 12 which is pre-configured with a recess 90 and a second deformable seal 80 in valve seat body 13 also preconfigured with recess 84. As seen in FIG. 5, the recesses 84 and 90 face, and are aligned with one another, to form a pocket 92 at the situs of engagement between the valve member 12 and the valve seat body 13, resulting in the advantages previously discussed.

FIG. 6 is yet another alternative embodiment of the valve assembly 11. In the embodiment illustrated in FIG. 6, the engagement surface 32 includes a recessed channel 130 extending between a first deformable seal 132 and a second and spaced apart deformable seal 134. As illustrated, the seals 132 and 134 are secured within cavities 138 having chamfered corners 140 so that as the seals 132 and 134 are compressed, the seals deform within the chamfers. As discussed below, the deformation of the seals 132 and 134 enables metal-to-metal contact between the surfaces 17 and 32 without causing damage to the seals 132 and 134.

In operation, as the valve member 12 moves in the downward direction (direction of arrow 10) to the closed position, the seals 132 and 134 initially contact seating surface 17. Upon initial contact, the recessed channel 130, the seals 132, 134, and the seating surface 17 form a pocket 136 to trap fluid therein. Continued movement of the valve member 12 toward the closed position compresses and otherwise deforms the seals 132 and 134 and increases fluid pressure within the pocket 136, which slows the velocity of the valve member 12 toward the valve seat 13. This reduces the impact force between the seating surface 17 and the engagement surface 32. In addition, the pressure of the trapped fluid creates a force F, which acts against the closing force on the valve member 12. Accordingly, when the engagement surface 32 contacts the seating surface 17, the closing pressure force is reduced by the opposite acting pressure force F, which reduces the axial load on the valve member 12 and the valve seat body 13. As such, any damage to the surfaces 17 and 32 caused by fracturing fluid particulate being sandwiched therebetween is substantially reduced. Furthermore, since a defined volume of fracturing fluid remains within the pocket 136, the particulate remains floating within the fracturing fluid and does not directly press against the surfaces 17 and 130.

While the embodiment illustrated in FIG. 6 discloses the recess 130 and the seals 132 and 134 on the valve member 12, seals 132 and 134 are optionally positionable on the valve seat body 13 in similar fashion. Furthermore, valve assembly 11 is configurable such that the recess 130 along with the seals 132 and 134 are positionable on both the valve member 12 and the valve seat body 13 so as to be aligned and facing each other to form the pocket 136 therebetween. While the embodiments illustrated in FIGS. 1, 2A, 2B and 6 illustrate the chamfers 35 and 140, other embodiments disclosed herein are optionally configurable to incorporate chamfers therein to facilitate the deformation the deformable seals while minimizing and/or eliminating damage thereto.

Any of the previously described valve assemblies 11 may be used to particular advantage when incorporated with a reciprocating pump apparatus, for example, the reciprocating pump apparatus of the type disclosed and described in U.S. Pat. No. 7,364,412, issued Apr. 29, 2008, and assigned to the assignee of the present disclosure. The description in such patent is incorporated by reference in its entirety. For example, and as diagrammatically illustrated in FIG. 7, any herein described valve assembly 11 may be used as an inlet valve 100 and/or an outlet valve 102 to move fluid back and forth from a fluid chamber 104 with a reciprocally movable piston 105, thereby respectively opening the inlet valve 100 to draw fracturing fluid into the chamber 104 (with outlet valve spring biased closed) and opening the outlet valve 102 to allow the fluid to flow therethrough (with inlet valve spring biased closed).

According to embodiments disclosed herein, the valve assembly 11 is manufactured by providing a valve seat body having a tubular shaped member 15 and a seating surface 17. The method further includes positioning a valve member 12 at least partially within the tubular shaped member 15, the valve member 12 having an engagement surface 32 to contact the seating surface 17 when the valve member 12 is in a closed position. The method also includes securing a seal 33 to at least one of the seating surfaces 17 or the engagement surfaces 32, the seal 33 having the preconfigured recess 41 is disposed therein to form the pocket 47 to trap fluid therein as valve member 12 approaches the closed position. The method also includes securing the seal 33 within the cavity 34 on the at least one of the seating surface 17 or the engagement surface 32. For example, during manufacture and assembly, the seal 33 is preferably molded in place such that the first surface 33a and at least a portion of the side surfaces 33d and 33e are disposed within the cavity 34; however, the seal 33 can be otherwise installed and secured within the cavity 34. Furthermore, the seal 33 is also attachable on top of the seal surfaces 32 (via an adhesive or otherwise) not having the cavities 34.

Various modifications may be made to the embodiments described herein without departing from the principles of the invention. For example, while the valve member 12 has been described as having a plurality of legs 25, a variety of different designs may be employed for the valve members. Moreover, although in each of the described embodiments the angle of the engagement surfaces of the valve member and valve seat body are the same, the principle of operation are the same if the angles slightly differ.

Furthermore, while in certain embodiments, valve assemblies have been described herein to operate in conjunction with reciprocating pumps in the presence of highly abrasive fluids, such as fracturing fluids, it is to be understood that many other applications for said valve assemblies lie within the scope of the invention. For example, the valve assemblies can be used in pumps pumping drilling fluid directly into the well bore, mining slurry through a pipeline, in pumps that are used to plump fluid with fluid particulars, or in applications other than pumps.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose.

In the specification and claims, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s), as defined solely by the appended claims. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A valve assembly, comprising:
a valve member;
a valve seat body;
the valve member reciprocatably movable into and out of engagement with the valve seat body; and
at least one deformable seal positioned to be at the situs of engagement of the valve member with the valve seat body, the at least one seal preconfigured with a recess facing the situs to form a pocket to trap fluid therein as the valve member approaches the engagement, thereby reducing velocity of the valve member moving toward the engagement, reducing the impact force of the valve member on the valve seat body and reducing the axial load on the valve member and valve seat body.

2. The valve assembly of claim 1, wherein the at least one deformable seal is disposed on the valve seat body.

3. The valve assembly of claim 2, wherein the at least one deformable seal is disposed at least partially within a cavity on the valve seat body.

4. The valve assembly of claim 2, further including a seal disposed on the valve member to contact the valve seat body seal as the valve member approaches the engagement.

5. The valve assembly of claim 2, further including a seal disposed on the valve member to contact the valve seat body seal as the valve member approaches the engagement, the valve member seal including a recess facing the recess disposed on at least one deformable seal on the valve seat body to form a pocket to trap fluid therein as the valve member approaches the engagement.

6. The valve assembly of claim 1, wherein fluid remains in the pocket after the engagement.

7. The valve assembly of claim 1, wherein the recess is arcuately formed on the seal.

8. The valve assembly of claim 1, the seal is formed of urethane.

9. The valve assembly of claim 1, wherein fluid remains in the at least one seal after the engagement.

10. The valve assembly of claim 1, wherein the valve seat body has an inclined seating surface disposed at an angle from about 30 degrees to about 45 degrees relative to a plane that is perpendicular to a central axis of the valve assembly.

11. A valve assembly incorporated with a reciprocating pump, the valve assembly movable between an open position and a closed position for respectively opening and closing a fluid chamber of the pump, the valve assembly comprising:
a valve member reciprocatably movable between the open and closed positions, the valve member having an engagement surface;
a valve seat body having a seating surface, the engagement surface of the valve member being biased into engagement with the seating surface of the valve seat body in the closed position and biased out of engagement from the seating surface in the open position; and
at least one deformable seal disposed at the situs of the engagement between the engagement surface and seating surface, the seal preconfigured with a recess facing the situs to form a pocket to trap fluid therein as the valve member approaches the engagement to reduce the velocity of the valve member toward, and reduce the impact force and axial load at, the engagement.

12. The valve assembly of claim 11, wherein the at least one deformable seal is disposed on the seating surface.

13. The valve assembly of claim 11, wherein the at least one deformable seal is disposed at least partially within a cavity on the seating surface.

14. The valve assembly of claim 11, wherein the recess is arcuately formed on the at least one deformable seal.

15. The valve assembly of claim 12, further including a seal disposed on the engagement surface to contact the at least one deformable seal on the seating surface as the valve member moves toward the closed position.

16. The valve assembly of claim 15, wherein the engagement surface seal is disposed at least partially within a cavity on the engagement surface.

17. The valve assembly of claim 12, further including a seal disposed on the engagement surface to contact the at least one deformable seal on the seating surface as the valve member moves toward the closed position, the engagement surface seal including a recesses facing the recess on the at least one deformable seal to form a pocket to trap pressurized fluid therein.

18. A method of manufacturing a valve for a reciprocating pump, the method comprising:
providing a valve seat body having a tubular shaped member, the valve seat body including a seat surface;
positioning a valve member at least partially within the tubular shaped member, the valve member having an engagement surface to contact the seat surface when the valve member is in a closed position;
securing a seal to at least one of the seat surface or the engagement surface, the seal having a preconfigured recess disposed therein to form a pocket to trap fluid therein as the valve member approaches the closed position.

19. The method of claim 18, wherein securing the seal to the at least one of the seat surface or the engagement surface includes securing the seal within a cavity.

20. A deformable seal for use with a reciprocating pump valve assembly, the pump valve assembly including a valve seat body having a seat surface, a valve member having an engagement surface for contacting the seat surface at a situs of engagement when the valve member moves to a closed position, the deformable seal comprising:
a first surface, a second surface and a pair of side surfaces; and
a recess formed in the second surface and adapted to face the situs of engagement such that as the valve member moves from an open position to the closed position, fluid is trapped within the second surface recess to reduce the velocity of the valve member toward, and reduce the impact force on, the seat surface, and to reduce the axial load between the valve member and valve seat body.

21. The seal of claim 20, wherein the first surface and at least a portion of the side surfaces are adapted to be disposed within a cavity on the seat surface or the engagement surface.

22. The deformable seal of claim 20 in combination with a valve member.

23. The combination of claim 22, wherein the valve member is otherwise as defined in claim 1.

24. A valve assembly, comprising:
a valve seat body;
a valve member, the valve member reciprocatably movable into and out of engagement with the valve seat body;
a first deformable seal positioned in the valve seat body and preconfigured with a recess;
a second deformable seal positioned on the valve member and preconfigured with a recess, and
the recesses on the first and second deformable seals are aligned and facing each other to form a pocket to trap fluid therein as the valve member approaches the valve seat body, to reduce the velocity of the valve member toward, and reduce the impact force against, the valve seat body, and to reduce the axial load on the valve seat body and valve member.

25. In a valve assembly manufactured with a valve member movable between an open position and a closed position, the valve member having an engagement surface for contacting a valve seat having a seating surface, the improvement comprising:
a deformable seal disposed on the engagement surface or the valve seat surface, the at least one deformable seal preconfigured with a recess for facing the seating surface or engagement surface without the deformable seal so as to trap fluid therein as the valve member moves to the closed position.

26. A valve assembly, comprising:
a valve member having an engagement surface;
a valve seat body having a seating surface;
the valve member reciprocatably movable into and out of engagement with the valve seat body; and
at least one of the engagement surface or the seating surface having a recessed portion disposed between a first deformable seal and a second deformable seal, the recessed portion and the first and second seals facing the situs of engagement to form a pocket to trap fluid therein as the valve member approaches the engagement, thereby reducing velocity of the valve member moving toward the engagement, reducing the impact force of the valve member on the valve seat body and reducing the axial load on the valve member and valve seat body.
